(19) United States
(12) Patent Application Publication
(10) Pub. No.: US 2023/0227730 A1
(43) Pub. Date: Jul. 20, 2023

(54) DEVICE AND METHOD FOR THE PYROLYSIS OF ORGANIC STARTING MATERIALS

(71) Applicant: CRR - CARBON RESOURCES RECOVERY GMBH, Berlin (DE)

(72) Inventors: Eckard PELZ, Mittweida (DE); Martin LÖFFLER, Berlin (DE)

(21) Appl. No.: 18/001,175

(22) PCT Filed: Jun. 9, 2021
(86) PCT No.: PCT/EP2021/065485

§ 371 Date: Dec. 8, 2022

(30) Foreign Application Priority Data
Jun. 9, 2020 (DE) 10 2020 115 348.1

(51) Int. Cl. C10B 47/30; C10B 47/44; C10B 53/07; C09C 1/48

(52) U.S. Cl. CPC C10B 47/30; C09C 1/482; C10B 47/44; C10B 53/07

(57) ABSTRACT

The invention relates to a system for the pyrolysis of waste material, in particular to the depolymerization of comminuted old tire material, and for producing an output material which can be further processed to form recovered carbon black. The system comprises at least one rotary kiln reactor, a quenching unit and burner unit. The rotary kiln reactor has a reactor drum, rotating during operation about a longitudinal axis, the interior of which has at least one heating zone, a reaction zone and a degassing zone. The burner unit is designed to burn pyrolysis gas to form a heating gas and to generate a heating gas flow through the heating jacket space, and is for this purpose connected to the heating jacket housing by way of heating gas lines.

The present invention relates to a device and a method for the pyrolysis of organic starting material.

A pyrolysis describes in general a thermal splitting of organic compounds. Here, in the absence of oxygen and at high temperatures, for example between 300° C. and 900° C., the bonds within larger molecules of a source material are forced to break. By means of the pyrolysis of the solid source material, as a rule, gases, liquids and solids are obtained, wherein the gases and liquids are discharged from a pyrolysis vapor resulting from the pyrolysis. The proportions and combinations are in this regard dependent on the source material, the pyrolysis temperature, the pressure conditions and the duration of the reaction. When polymers are subjected to pyrolysis, an associated polymer frequently results as a part of the pyrolysis vapor.

Devices and methods for the pyrolysis of organic starting materials are basically known.

For example, from the publication EP 0 592 057 B1, a method is known for the pyrolysis of old tires, in which the old tires are broken down in a pyrolysis in a metal bath under conditions of reduced pressure and in the absence of air and water. The pyrolysis vapor resulting from the pyrolysis is separated off into a gaseous or a liquid phase after cooling. Furthermore, the method provides that a part of the gaseous phase is subsequently supplied back into the reactor interior above the metal bath and that moreover oxygen is continuously supplied to the reactor interior above the metal bath. In the method known from this publication, the pyrolysis reaction is predominantly controlled by regulating the speed of the gas flow in the reaction chamber.

A method in which the pyrolysis is carried out in a continuous process in a rotary kiln reactor is known from DE 10 2014 015 281 A1.

An important product which can be obtained from the pyrolysis of old tires is soot, in particular valuable soot described as “carbon black” which has a large specific surface area.

In order to generate a material which is suitable for the further processing to form recovered carbon black, a continuous process for the depolymerization or pyrolysis of waste rubber must be carried out such that
1. the reaction temperature and quantity of reaction heat achieves the depolymerization of the rubber components and nevertheless a further deeper splitting of the hydrocarbons to form carbon is avoided,
2. the conditions in the reactor after the end of the reaction phase (zone) ensure a virtually complete removal of the hydrocarbon residues from the remaining flow of solids, and
3. the hot gaseous fission products are guided rapidly out of the reactor interior at the location of their formation and are cooled abruptly, in order to avoid recombination (renewed polymerization) of the fission products and thus the formation of high-boiling components and their deposition on the solid.

Material from pyrolysis processes which is suitable for the further processing to form recovered carbon black is characterized in that the proportion in the material which can be extracted by toluene -e.g. the oil content - is less than 1%, preferably less than 0.5%. Furthermore, the morphology of the carbon particles is decisive for the intended use as a filler in rubber and plastic applications. Additional carbon formed in the pyrolysis does not have the morphological properties of conventional carbon black and reduces the quality of the end product. The proportion of the total carbon described as oil-carbon or also “char” should not exceed 2%.

A technical problem upon which the present invention is based is the creation of an improved device for the continuous pyrolysis of organic starting material.

According to the invention, a system is proposed for the pyrolysis of waste material, in particular for the depolymerization of comminuted old tire material, and for producing a starting material which can be further processed to form recovered carbon black. The system comprises at least one rotary kiln reactor, a quenching unit and burner unit.

The rotary kiln reactor has a reactor drum, rotating during operation about a longitudinal axis, having a drum wall which encloses a reactor interior. On the inner side of the drum wall are arranged conveying devices which, when the reactor drum rotates, effect a conveying of the waste material to be processed. The reactor interior has at least one heating zone, a reaction zone and a degassing zone. The reactor drum has a waste material inlet and a (pyrolysis) solids outlet and a (pyrolysis) gas outlet. The reactor drum is enclosed by a heating jacket housing and is rotationally mounted such that the reactor drum can turn about can turn about its rotational axis within the heating jacket housing. The heating jacket housing encloses a heating jacket space which is delimited inside by the drum wall of the reactor drum.

The burner unit is designed for burning gas (preferably pyrolysis gas) to form a heating gas and for generating a heating gas flow through the heating jacket space and to this end is connected via heating gas supply lines to the heating jacket housing such that the heating gas can be conducted into the heating jacket space, such that the reactor drum located in the heating jacket space can be heated indirectly from the outside by means of the heating gas.

The quenching unit is connected to the gas outlet of the rotary kiln reactor and is designed for cooling pyrolysis gases resulting in the reactor interior during operation.

According to the invention, several heating gas outlet flaps are distributed across the length of the heating jacket housing, which allow the flow of the heating gas through the heating jacket space to be influenced such that respectively different heat quantities can be supplied to the heating zone, the reaction zone, and the degassing zone in the reaction interior.

Preferably, the conveying devices are transport spirals which are formed by projections extending along a helical path, starting from the drum wall and protruding to the inside into the reactor interior.

Preferably, the helical turns of the transport spirals have a different pitch in the reaction zone and in the degassing zone, in order in this manner to optimize the remain times of the pyrolysis material in the different zones.

The knowledge upon which the invention is based regarding the specific process conditions and constructional characteristics of the components of the system result in solutions, in order, on the one hand, to further improve the effectiveness of the method in its use for the pyrolysis of old tires/old rubber, and on the other hand to guarantee the required quality of the pyrolysis products.

The invention involves the knowledge that for continuously working systems - in contrast to pyrolysis processes which work on a batch basis (intermittently) - particular challenges arise in order to guarantee a high level of process stability and even product qualities over a long period of operation. For this reason, a finely-tuned (regulated) process workflow for the entire system of rotary kiln reactor, quenching unit and burner system is necessary. A further problem for a permanently stable process management consists in the solid particles carried along with the hot fission gases in the transition from the reactor interior to the quenching unit being gradually deposited, and can ultimately result in a blockage of the pipeline between reactor and quenching unit.

With the system according to the invention and the method according to the invention, it is possible to adapt the remain times of the pyrolysis material in the individual zones in the interior of the reactor chamber such that the respective processes such as heating, fission reaction (pyrolysis/depolymerization) and residual degassing take place completely and in the relevant zones at a predetermined rotational speed of the reactor drum and with continuous passage of pyrolysis material. To this end, the transport spirals in the interior of the reactor drum have different pitches depending on the zones. The drum diameter of individual longitudinal portions of the reactor drum and the spacing between the helical turns of the transport spirals is also zone-related and selected such that fill level and mixing of the fill are sufficient for the process currently running. In addition to a gut thermal transition from the reactor jacket space to the drum wall and from the drum wall to the pyrolysis material, it is necessary, for a sufficient transition of material and heat, for the solid fill to be well mixed. The mixing is realized by lifting blades arranged in the helical turns.

By means of the rotation of the reactor drum and the movement of the material in the reactor drum, a portion of the solids is churned and transported away with the hot fission gases. A disadvantage of a previous reactor construction was the arrangement of the gas outlet at the end of the reactor drum. Thus, the solid (in the form of dust) churned up in the degassing zone is borne by the fission gases resulting in the reaction zone and is carried out. In order to avoid this problem, preferably a pyrolysis gas outlet pipe is provided with which the fission gases can be removed directly from the reaction zone and guided to the quenching unit. A pyrolysis gas outlet pipe protruding at the outlet into the reactor drum and passing through the degassing zone as far as the end of the reaction zone has established itself as a solution for countering this disadvantage. At the same time, this solution guarantees that the fission products are able to leave the reactor interior more rapidly and thus the aforementioned disadvantages (recombination and additional formation of fission carbon) are also avoided, and thus the quality of the recovered carbon black is improved.

A complete retention of solids from the gas phase is not possible, even with the aforementioned solution. In the longer term, deposits of coke-like compounds and carbon dust form in the pyrolysis gas outlet pipe between quenching unit and reactor chamber. Their removal is achieved by a pipe-cleaning device which is operated at regular intervals (e.g. twice weekly). During the pipe cleaning procedure, the pyrolysis process is briefly interrupted, in that no material is supplied, in order to interrupt the formation of fission gas. The pipe-cleaning device is characterized in that a cleaning element which fills the entire pipe diameter of the pyrolysis gas outlet pipe is guided by means of a gear rack through the pyrolysis gas outlet pipe - starting at the quench entrance and reaching to the pipe end within the reactor drum, wherein the deposits are removed and transported as far as an input opening of the pyrolysis gas outlet pipe, and thus enter into the reaction zone of the reactor drum. Subsequently, the gear rack with the cleaning element is moved back again and thus removed completely from the pyrolysis gas outlet pipe. The gear rack is driven by a drive unit with a gear motor and a gearwheel. In the rest position, the gear rack, the cleaning element and the drive gearwheel are in a sealed pipe piece situated directly opposite to the pyrolysis gas outlet pipe.

In the rest position, the gear rack, the cleaning element and the drive gearwheel are in a sealed pipe piece situated directly opposite to the pyrolysis gas outlet pipe. The heating gas generated in the burner chamber by burning pyrolysis gases with air reaches a temperature there of 850° C. The heating gas is mixed in a mixing path with recirculating and already-used heating gas, in order to achieve the necessary heating gas temperature of 580 to 680° C. and to provide a large volume flow of heating gas. The regulated heat supply to each reactor is achieved by heating gas inlet flaps at the lower entrance to the heating jacket space of the rotary kiln reactors on the input side.

The heat distribution across the longitudinal direction of the reactor drums is realized by heating gas outlet flaps arranged at the top of the heating jacket housing, which are distributed across the length of the heating jacket housing, and the respective opening degree of which ensures the heat requirement of the respective reactor zone. For setting an optimum heat distribution, it is advantageous when the positions (opening degrees) of the heating gas outlet flaps are able to be adjusted very precisely, and when they are coordinated. A preferred configuration of the flap positions which has proved advantageous for tire chippings effects a distribution of the supplied heat quantity of 20% for the heating zone, 70% for the reaction zone and 10% for the degassing zone of the reactor drum. The used heating gases which pass across the heating gas outlet flaps of the two heating jacket housings flow in the common line for recirculating the heating gas and typically have a temperature of 550° C.

The heating gas generated in the mixing path from recirculating heating gas and fresh heating gas from the burner unit which is not required for heating the reactors, can be supplied to a further thermal use as a heat transfer medium and subsequently, where appropriate, subjected to a flue-gas purification.

An advantage results on the one hand from the heat distribution which can be achieved by this arrangement, and on the other hand from the possibility of compensating for fluctuations and interruptions in the process workflow in the reactor, without using primary energy in the form of natural gas or liquid gas for the burner unit. An interruption in the process of this sort can for example be the above-mentioned cyclical operation of the pipe-cleaning device. Pyrolysis gas provided by the suction fan of the quenching unit (syngas: non-condensed portion of the fission products) is completely burned in the burner unit.

Typically, the pyrolysis gas has a temperature of 40° C. at the quenching outlet. If there are fluctuations in the process workflow of a reactor and if there is an increased heat requirement for the pyrolysis, the quenching outlet temperature of the pyrolysis gases can be increased by changing the quenching operation parameters. Thus, the pyrolysis gas quantity is increased by the components in the fission gas which would otherwise have condensed out into liquid and been present in the pyrolysis oil. The pressure regulation for the inner pressure of the reactors to a value in the range from 50 to 150 Pa above atmospheric pressure (0.5 to 1.5 mbar above atmospheric pressure) is realized by means of the suction fans of the quenching unit. Thereby, a reaction to fluctuations in the resulting pyrolysis gas quantity takes place, and the conveyed quantities in the suction fan is adapted, and the pyrolysis gases of the burner unit are supplied with a supply overpressure of 2000 to 6000 Pa (20 to 60 mbar above atmospheric pressure).

An embodiment example and further aspects of the invention are to be described in more detail with reference to the figures. The figures show the following:

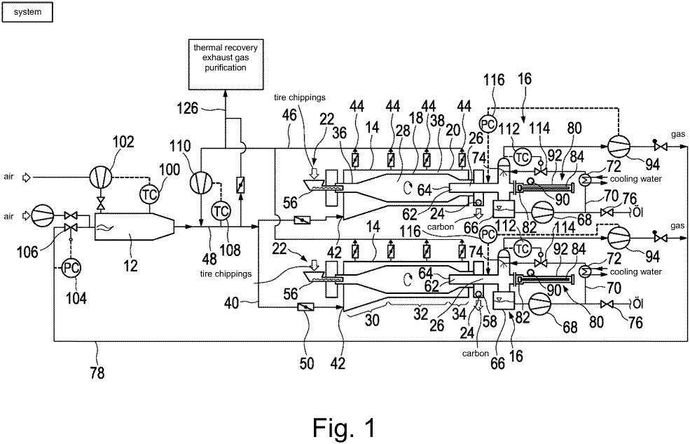

FIG. 1: shows a system for the pyrolysis of waste material, in particular for the pyrolysis of tire chips;

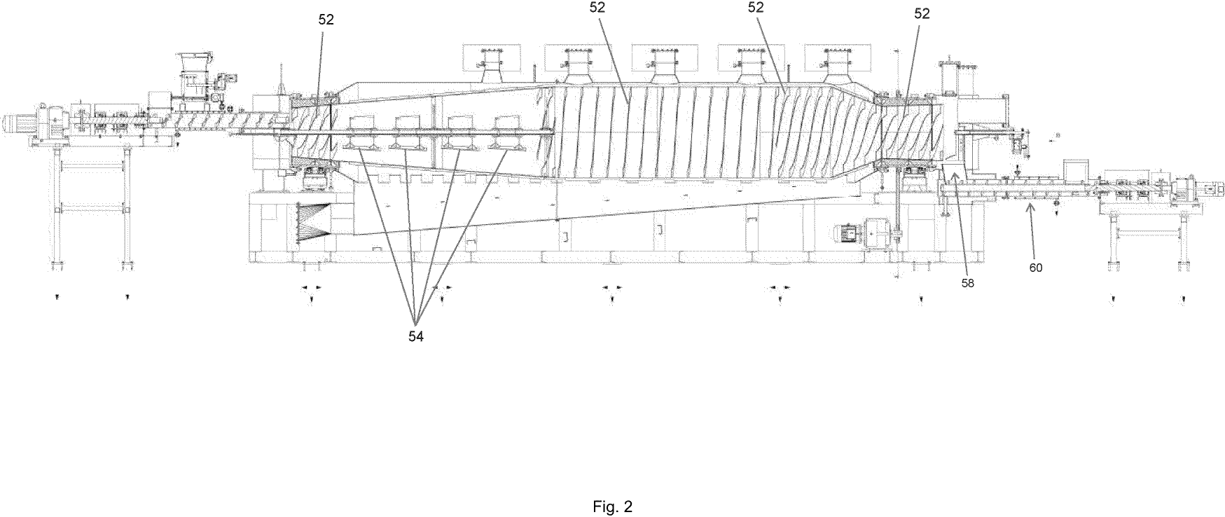

FIG. 2: shows a longitudinal section through a rotary kiln reactor according to the invention; and

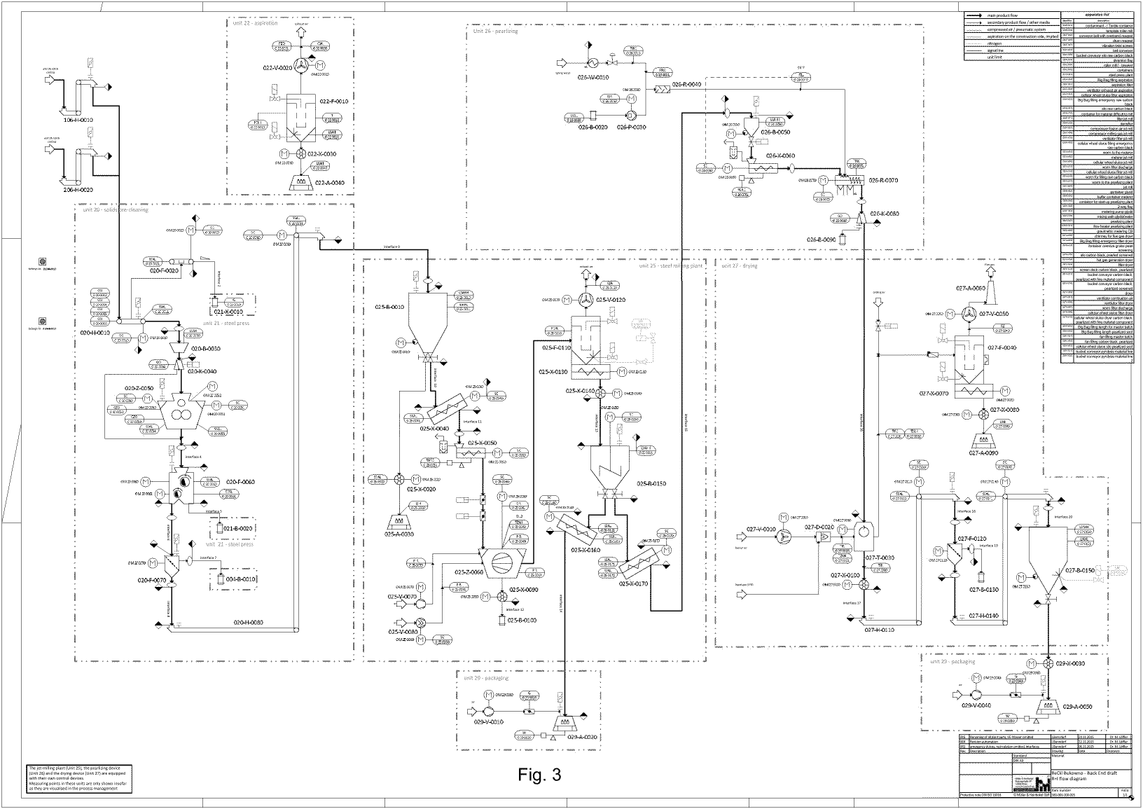

FIG. 3: shows devices for post-treatment of the pyrolysis solids;

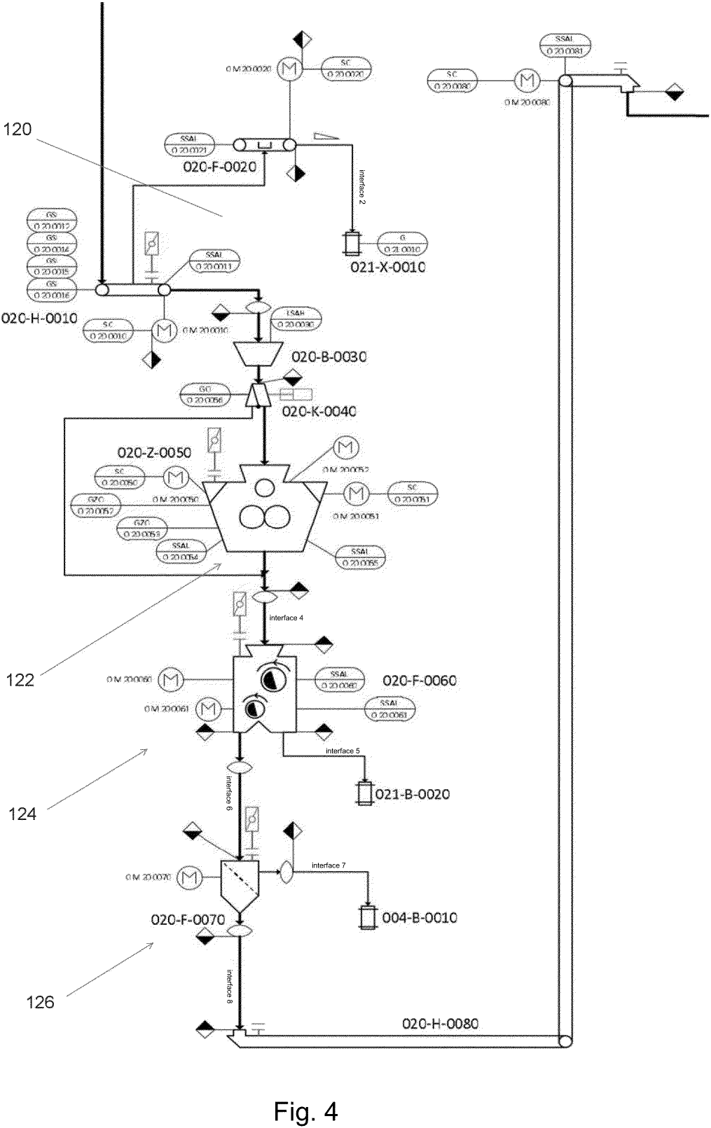

FIG. 4: shows devices for the pre-cleaning of solids as part of the devices for the post-treatment of the pyrolysis solids from FIG. 3;

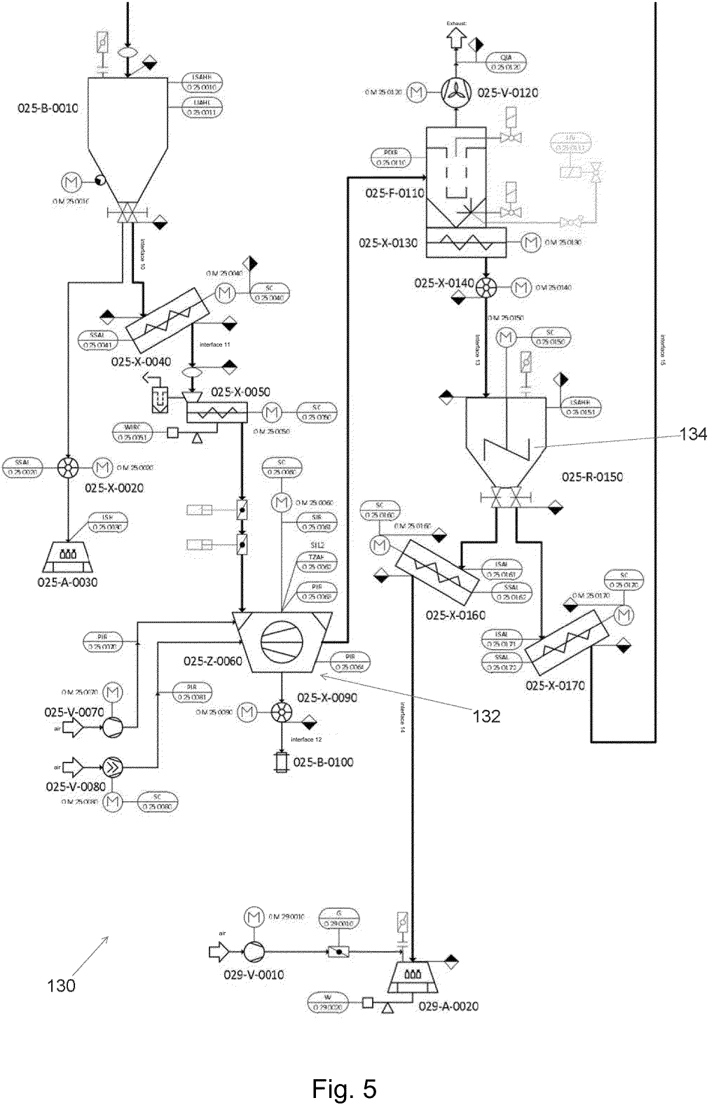

FIG. 5: shows a fine milling apparatus of the devices for the post-treatment of the pyrolysis solids from FIG. 3;

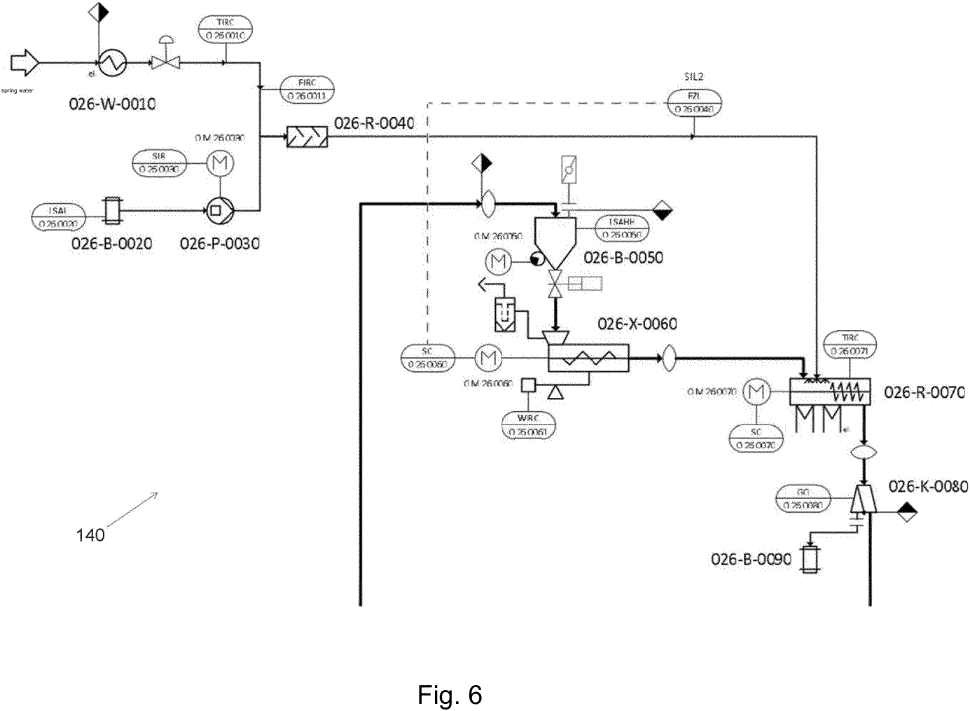

FIG. 6: shows a pearling device of the devices for the post-treatment of the pyrolysis solids from FIG. 3, and

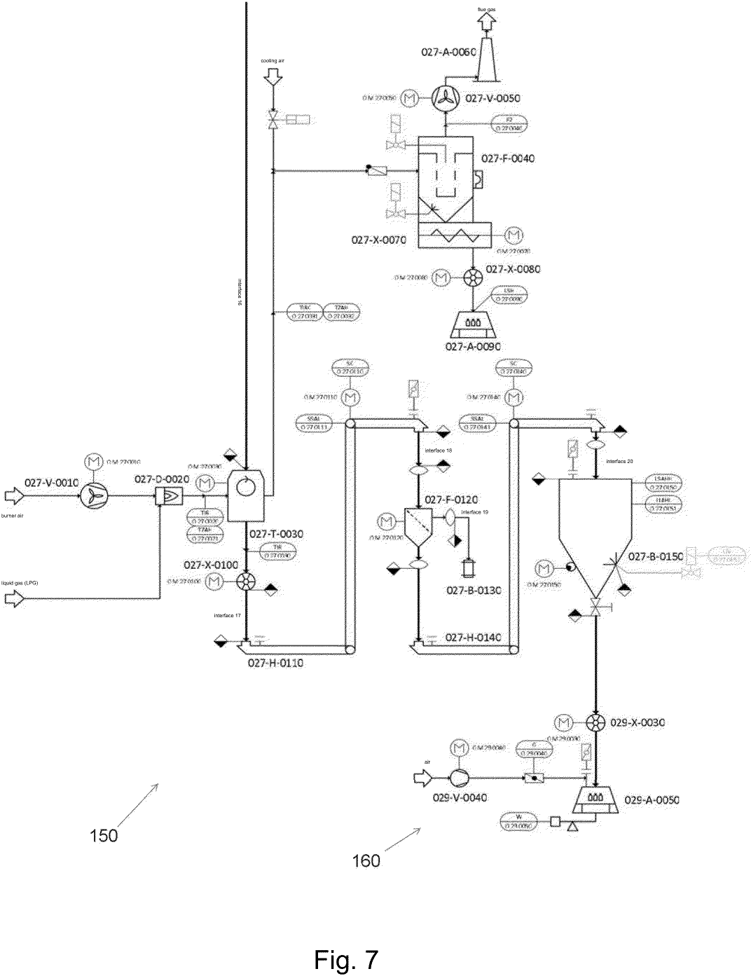

FIG. 7: shows a drying and a packing device of the devices for the post-treatment of the pyrolysis solids from FIG. 3.

A system 10 according to the invention for the pyrolysis of waste material comprises a burner unit 12, one or several rotary kiln reactors 14 and one or several quenching units 16; see FIG. 1.

The rotary kiln reactor 14 has a reactor drum 18 which is arranged in a heating jacket housing 20 so as to be rotatable about a rotational axis.

The reactor drum 18 has at one of its longitudinal ends a waste material inlet 22 and at the other of its longitudinal ends a pyrolysis solids outlet 24. The reactor drum 18 encloses a reactor interior 28 and forms in this reactor interior 28 a heating zone 30, a reaction zone 32 and a degassing zone 34. The reactor interior 28 is enclosed by a drum wall 36, which in turn is enclosed by the heating jacket housing 20, such that a heating jacket space 38 results between the heating jacket housing 20 and the drum wall 36, in which heating gas can be introduced.

The heating gas for heating the reactor drum 18 and its contents are generated by the burner unit 12. By means of a heating gas supply line 40, heating gas is guided from the burner unit 12 to a heating gas inlet 42 into the heating jacket housing 20. The heating gas inlet 42 is arranged in the vicinity of the waste material inlet 22 below the same. Above the reactor drum 18, the heating jacket space 38 has several heating gas outlet flaps 44 distributed along the longitudinal axis of the reactor drum 18, the opening degree of which can be set and adjusted. Thus, heating gas entering through the heating gas inlet 42 into the heating jacket space 38 can flow around the drum wall 36 to the heating gas outlet flaps 44 and in this manner heat the reactor drum 18 and its contents from the outside.

By setting and, where necessary, controlling the opening degree of the individual heating gas outlet flaps 44, the temperature distribution in the heating jacket space 38 and thus also the temperature distribution in the reactor interior 28 can be controlled and set. In this manner, it is, in particular, possible to set suitable temperatures for the heating zone 30, the reaction zone 32 and the degassing zone 34 in the reactor drum 18.

Heating gas emerging through the heating gas outlet flaps 44 out of the heating jacket space 38 is guided back again by means of a heating gas recirculation line 46 and can be mixed with heating gas generated by the burner unit 12.

For an efficient operation of the pyrolysis reactors, an arrangement has proved suitable in which a burner unit 12 supplies two rotary kiln reactors 14 with heating gas. There, the heating gas generated by the burner unit 12 by burning the pyrolysis gases with air reaches a temperature of 850° C. The heating gas is mixed with recirculated and already used heating gas in a heating gas mixing path 48, in order to reach the required heating gas temperature of 580 to 680° C. and to provide a large volume flow of heating gas.

The regulated heat supply to each rotary kiln reactor 14 takes place by way of heating gas inlet flaps 50, at the lower heating gas inlet 42 on the input side, to the heating jacket space 38 of the rotary kiln reactors 14. The heat distribution across the length of the reactor drum 18 is realized by heating gas outlet flaps 44 distributed longitudinally across the length of the heating jacket housing at the top, the respective opening degree of which meets the heating requirement of the respective reactor zone 30, 32 and 34 For setting an optimal heat distribution, it is advantageous when the positions (opening degrees) of the heating gas outlet flaps 44 are able to be set very precisely and are coordinated. A preferred flat position configuration which has proved suitable for tire chippings effects a distribution of the supplied heat quantity of 20% for the heating zone 30, 70% for the reaction zone 32 and 10% for the degassing zone 34 of the reactor drum 18.

The used heating gases passing across the heating gas outlet flaps 44 of the two heating jacket housings 20 flow into the collection line 46 of the recirculation and typically have a temperature of 550° C. The heating gas generated in the heating gas mixing path 48 from recirculating heating gas and fresh heating gas from the burning unit 12, which is not required for the heating of the rotary kiln reactors 14, can be supplied to a further thermal use as a heat transfer medium and subsequently, where appropriate, subjected to a flue gas cleaning An advantage results on the one hand from the heat distribution which can be achieved by this arrangement and on the other hand from the possibility of compensating for fluctuations and interactions in the process of a reactor without using primary energy in the form of natural gas or liquid gas for the burner unit 12.

Preferably, the burner unit 12 is thus connected to two rotary kiln reactors 14, such that heating gas is guided by way of two heating gas lines (of which each leads to one rotary kiln reactor) to the two rotary kiln reactors 14 and, in the same way, heating gas emerging from the respective jacket housing 20 can be supplied back via one common heating gas recirculation line 46 arranged at the top and centrally between the two rotary kiln reactors.

A further improvement of the pyrolysis process - as an alternative or in addition to the previously described temperature setting - results from a construction of the reactor drum which results in suitable remain times of the pyrolysis material in the individual zones 30, 32, 34 in the interior of the reactor drum. The remain times are constructionally set such that the respective processes such as heating in the heating zone 30, fission reaction or pyrolysis for depolymerization in the reactor zone 32 and residual degassing in the degassing zone 34 take place completely and in relation to the zones, with a predetermined rotational speed of the reactor drum 18 and predetermined throughput of pyrolysis material.

The transport of the pyrolysis material in longitudinal direction of the reactor drum 18 from its waste material inlet 22 until the pyrolysis solids outlet 24 is effected by transport spirals 52 which are arranged in the interior of the reactor drum 18 starting from the drum wall 36 and protruding to the inside; see FIG. 2. The transport spirals 52 in the interior of the reactor drum 18 have different pitches depending on the zone. A transport spiral 52.1 in the heating zone 30 thus has a pitch which is different from that of a transport spiral 52.2 in the reaction zone 32 or a transport spiral 52.3 in the degassing zone 34. Moreover, the reactor drum 18 has different drum diameters along its longitudinal axis. In the reaction zone 32, the drum diameter is at its maximum. The spacing of the helical turns of the individual transport spirals 52.1, 52.2 and 53.3 is also not identical in all three zones. On the contrary, the respective drum diameter of the transport drum 18 and the spacing between the helical turns of the transport spirals 52 are sized for each of the three zones such that a desired fill level and a desired mixing of the fill of the pyrolysis material is suitable for the process which is running in each case - that is, heating, fission reaction and residual degassing.

In addition to a good thermal transfer from heating jacket space 38 two drummer wall 36 and from the rumble 36 to the pyrolysis material in the reactor interior 38, for a sufficient material and heat transfer, it is necessary for the solids fill of pyrolysis material to be well mixed. The mixing is realized by lifting blades 54 arranged in the helical turns of the transport spirals 52.

During operation of the rotary kiln reactor 14, waste material, for example tire chippings, is supplied as pyrolysis material via the waste material inlet 22 of the reactor drum 18. This is achieved by a feeding screw conveyor 56, which conveys the waste material from the waste material inlet 22 into the reactor drum 18. In the reactor drum 18, the waste material is conveyed from the transport spiral 52.1 to the heating zone 30 and is mixed within the heating zone 30 by the lifting blades 54. The pyrolysis material, that is, for example, the old tire chippings, are subsequently conveyed in the reaction zone 32 by the transport spiral 52.2 further into the degassing zone 34. The pyrolysis material, that is, for example, the old tire chippings, are subsequently conveyed in the reaction zone 32 by the transport spiral 52.2 further into the degassing zone 34. At the pyrolysis solids outlet 24, the pyrolysis solids generated in the reactor drum 18 fall into a collecting chute 58, from which it is transported away by a discharge screw conveyor 60.

Pyrolysis gas resulting during the pyrolysis can emerge out of the reactor interior 28 by way of a pyrolysis gas outlet pipe 62. Advantageously, the pyrolysis gas outlet pipe 62 extends from the pyrolysis gas outlet 26 into the reaction zone 32. The pyrolysis gas outlet pipe 62 runs centrally in the reactor drum 18 along the rotational axis of the reactor drum 18, wherein it is not necessary for the pyrolysis gas outlet pipe 62 to run precisely along the rotational axis of the reactor drum 18. Pyrolysis gas resulting during the pyrolysis in the reactor interior 28 can enter an inlet opening 64 of the pyrolysis gas outlet pipe and can flow through the pyrolysis gas outlet pipe 62 through the pyrolysis gas outlet 26 to the quenching unit 16. The inlet opening 64 of the pyrolysis gas outlet pipe 62 is in this regard located, as already stated, in the region of the reaction zone 32. Thereby solids churned up in the degassing zone 34, which are typically dust-like, are to the main extent prevented from being borne along by the pyrolysis gases resulting in the reaction zone 32 and carried out through the pyrolysis gas outlet 26 and out of the reactor interior 28. A further advantage of the pyrolysis gas outlet pipe 62 protruding into the reaction zone 32 is that the fission products resulting during the pyrolysis - that is the pyrolysis gas - are able to leave the reactor interior 28 more rapidly, and disadvantages such as the recombination of the fission products and the additional formation of fission carbon can be avoided. In this manner, the quality of the recovered carbon black is further improved.

In the quenching unit 16, the pyrolysis gases emerging from the pyrolysis gas outlet pipe 62 are cooled, such that the pyrolysis gases with a higher evaporation temperature are liquefied to form pyrolysis oil. The liquid resulting in the quenching unit 16 - the pyrolysis oil - is captured in a capture container 66 at the lower end of the quenching unit 16 and conveyed by means of a pump 68. A portion of the pyrolysis oil is passed by way of a pyrolysis oil recirculation line 70 through a liquid cooler 72 and passed back again to the quenching unit 16 and there sprayed by means of a spraying unit 74. Pyrolysis oil arising in the quenching unit is discharged by way of a liquid outlet 76, if it is not recirculated. Pyrolysis gas remaining in the quenching unit 16 which is not liquefied is finally supplied by way of a pyrolysis gas line 78 to the burner unit 12 and there burned to form heating gas.

Pyrolysis gas provided by the quenching unit 16 is a syngas, which is formed from the non-condensed portions of the fission products of the pyrolysis. The pyrolysis gas typically has a temperature of 40° C. at the output of the quenching unit 16. If fluctuations occur in the process workflow of one or both rotary kiln reactors 14 and there is an increased heat requirement for the pyrolysis, the quenching output temperature of the pyrolysis gases can be increased by changing the operation parameter values of the quenching unit 16. Thus, pyrolysis gas quantity is also increased by the components in the fission gas which would otherwise have liquefied in the quenching unit 16 and which had then been present in liquid, condensed form in the pyrolysis oil.

For adjusting and controlling the process parameters, the burner unit 12 is connected to a burner control unit 100, in order to be able to control the air supply to the burner unit 12 via a fan 102. A gas supply control unit 104 controls the pyrolysis gas supply which is supplied to the burner unit 12 by way of gas supply valve 106.

The recirculated heating gas quantity supplied to the heating gas mixing path 48 is regulated by means of a recirculation control unit 108 which controls the recirculation heating gas fan 110.

For regulating the quenching output temperature, a quenching temperature control unit 112 is provided which controls a pyrolysis oil circulation valve 114. In this manner, the quantity of the cooled pyrolysis oil which is sprayed into the quenching unit 16 can be controlled. As previously described, the circulated pyrolysis oil is cooled by means of a water cooler, such that the quenching output temperature can be controlled by way of the quantity of resupplied pyrolysis oil.

Moreover, a further processing unit 116 is provided for each of the rotary kiln reactors 14, which respectively controls the exhaust fan 94.

The rotary kiln reactors 14 are operated with an internal pressure in the reactor interior 28 which lies approximately 50 Pa to 150 Pa above atmospheric pressure. This over-pressure is realized by way of an exhaust fan 94 of the quenching unit 16. It is thus possible to react to fluctuations in the occurring pyrolysis gas quantity by adapting the flow rate in the exhaust fan 94. The pyrolysis gases are supplied to the burner unit 12 with a supply over-pressure of 2000 Pa to 6000 Pa above atmospheric pressure.

Since it is not possible to completely retain solids from the pyrolysis gas, despite the pyrolysis gas outlet pipe 62 protruding into the reaction zone 32, in the long term, deposits of coke-like compounds and carbon dust result in the pyrolysis gas outlet pipe 62. A pipe cleaning device 80 is provided for removing these deposits, which can be used at regular intervals, for example twice weekly. The pipe cleaning device 80 has a cleaning element 82, the outer diameter of which is equal to the inner diameter of the pyrolysis gas outlet pipe 62. The cleaning element 82 can be moved into gas outlet pipe 62 by means of a gear rack 84 as far as the inlet opening 64 of the pyrolysis gas outlet pipe 62. Thus, deposits in the pyrolysis gas outlet pipe 62 are removed and transported as far as the inlet opening 64 of the pyrolysis gas outlet pipe 62, such that they can reach the reaction zone 32 and the reactor drum 18 again in this manner. Subsequently, the cleaning element 82 can be moved back again by means of the gear rack 84 and be guided completely out of the pyrolysis gas outlet pipe 62. A drive unit 86 with a gear motor 88 and a drive gear 90 is provided to drive the gear rack 84. In their resting position, the gear rack 84, the cleaning element 82 and the drive gear 90 are located in a pipe piece 92 situated directly opposite the pyrolysis gas outlet pipe 62 on the output side.

When the pipe cleaning device 80 is used, the pyrolysis process is briefly interrupted, in that no waste material is supplied to the reactor drum 18, in order to interrupt the pyrolysis gas formation.

This constitutes an interruption in the pyrolysis process, the consequences of which can be reduced by appropriate settings of the heating gas outlet flaps 44. The consequences for smooth operation can be additionally minimized, as described above, by the operational conditions of the quenching unit 12.

The apparatuses depicted in FIG. 3, which can also be described as back-end, are provided for the post-treatment of the pyrolysis solids emerging from the reactor drum 18 by way of the pyrolysis solids outlet 58.

The pyrolysis solids emerging out of the reactor drum 18 are first subjected to a solids pre-cleaning; see FIG. 4. For this purpose, a device 120 is provided for the magnetic removal of coarse components from the pyrolysis solids. Thereafter, the pyrolysis solids, freed from coarse magnetic components, is supplied to a device 122 for the rough comminution of the pyrolysis solids. The device 122 comminutes the pyrolysis solids to form particles which are smaller than 2 mm. The roughly comminuted pyrolysis solids are then in turn supplied to a second device 124 for removing magnetic components. The device 124 removes the smallest magnetic components. The magnetic components removed by the device 120 and the device 124 can be supplied in each case to a steel press.

The pyrolysis solids, freed from fine magnetic components, are finally supplied to a device 106 for removing course components and textile components. The pyrolysis solids which have been precleaned in this manner are then supplied to a fine milling device, for example a jet-milling plant 110 as shown in FIG. 5. The jet-milling plant 130 has a jet-milling device with a classifying wheel 132, which serves for the comminution and classification of the pyrolysis solids and for the maintenance of an upper particle size limit of, for example, 15 µm. Instead of a jet-milling plant, a roller mill can also be used in interplay with a classifying wheel for classifying particles.

The milled pyrolysis solids are finally supplied to a stirring container which serves to remove air from the milled pyrolysis solids, in order to achieve an even and increased fill weight for a subsequent pearling.

A pearling device 140 is provided for the pearling, as is shown in FIG. 6. The pearling device 140 has a pin mixer and metering equipment for the supply of powder and a water-surfactant mixture.

After leaving the pearling device 140, the pearled pyrolysis solids are supplied to a drying apparatus 150, see FIG. 7. This has a drum drier or a fluidized-bed dryer for evaporating pearling water. The heat required for the drying apparatus 150 is preferably provided in part by the system 10 in the form of a heating gas quantity taken from the surplus heating gas from the recirculation line 46, and heat supplied by way of a heating gas outlet line 126 to a heat transfer medium; see also reference sign 126 in FIG. 1.

After the drying of the pearlized pyrolysis solids, there follows a screen classification for separating oversized and undersized grains from the product flow. Oversized and undersized grains are supplied back to the fine milling process 130.

Finally, the pearlized and screen-classified pyrolysis solids can be packed in a packing device 160.

List of reference numbers

| | |
|---|---|
| 10 | system |
| 12 | burner unit |
| 14 | rotary kiln reactors |
| 16 | quenching unit |
| 18 | reactor drum |
| 20 | heating jacket housing |
| 22 | waste material inlet |
| 24 | pyrolysis solids outlet |
| 26 | pyrolysis gas outlet |
| 28 | reactor interior |
| 30 | heating zone |
| 32 | reaction zone |
| 34 | degassing zone |
| 36 | drum wall |
| 38 | heating jacket space |
| 40 | heating gas supply line |
| 42 | heating gas inlet |
| 44 | heating gas outlet flaps |
| 46 | heating gas recirculation line |
| 48 | heating gas mixing path |
| 50 | heating gas inlet flap |
| 52 | transport spirals |
| 54 | lifting blades |
| 56 | feeding screw conveyor |
| 58 | collecting chute |
| 60 | discharge screw conveyor |
| 62 | pyrolysis gas outlet pipe |
| 64 | inlet opening |
| 66 | capture container |
| 68 | pump |
| 70 | pyrolysis oil recirculation line |
| 72 | liquid cooler |
| 74 | spraying unit |
| 76 | liquid outlet |
| 78 | pyrolysis gas line |
| 80 | pipe cleaning device |
| 82 | cleaning element |
| 84 | gear rack |
| 86 | drive unit |
| 88 | gear motor |
| 90 | drive gear |
| 92 | pipe piece |
| 94 | exhaust fan |
| 100 | burner control unit |
| 102 | fan |
| 104 | gas supply control unit |
| 106 | gas supply valve |
| 108 | recirculation control unit |
| 110 | recirculation heating gas fan |
| 112 | quenching temperature control unit |
| 114 | pyrolysis oil circulation valve |
| 116 | process control unit |
| 120 | device for the magnetic removal of coarse components |
| 122 | device for the course comminution of the pyrolysis solids |
| 124 | second device for removing magnetic components |
| 126 | heating gas outlet |
| 130 | fine milling plant |
| 132 | jet-milling plant |
| 134 | stirring container |
| 140 | pearling device |
| 150 | drying apparatus |
| 160 | packaging device |

What is claimed is:

1. A system for the pyrolysis of waste material, wherein the system comprises at least one rotary kiln reactor, a quenching unit and a burner unit, and
the rotary kiln reactor has a reactor drum, rotating during operation about a longitudinal axis, having a drum wall which encloses a reactor interior,
on the inner side of the drum wall are arranged conveying devices which, when the reactor drum rotates, effect a conveying of the waste material to be processed,
the reactor interior has at least one heating zone, a reaction zone and a degassing zone,
the reactor drum has a waste material inlet and a pyrolysis solids outlet and a pyrolysis gas outlet and is enclosed by a heating jacket housing and is rotationally mounted such that the reactor drum can turn about its rotational axis within the heating jacket housing, wherein the heating jacket housing encloses a heating jacket space which is delimited inside by the drum wall of the reactor drum,
the burner unit is designed for burning gas to form a heating gas and for generating a heating gas flow through the heating jacket space and to this end is connected via a heating gas supply line to the heating jacket housing such that the heating gas can be conducted into the heating jacket space such that the reactor drum located in the heating jacket space can be heated indirectly from the outside by means of the heating gas, and
the quenching unit is connected to the gas outlet of the rotary kiln reactor and is designed for cooling pyrolysis gases resulting in the reactor interior during operation,
characterized in that several heating gas outlet flaps are distributed across the length of the heating jacket housing, which allow the flow of the heating gas through the heating jacket space to be influenced such that respectively different heat quantities can be supplied to the heating zone, the reaction zone and the degassing zone in the reaction interior.

2. The system for pyrolysis according to claim 1, wherein the conveying devices are transport spirals which are formed by projections extending along a helical path, starting from the drum wall and protruding to the inside into the reactor interior, wherein the helical turns of the transport spirals have a different pitch in the reaction zone and in the degassing zone.

3. The system for pyrolysis according to claim 1, wherein the reactor drum has different drum diameters along its longitudinal axis and the drum diameter has its maximum size in the reaction zone.

4. The system for pyrolysis according to claim 1, wherein the system comprises a burner unit and two rotary kiln reactors each having one quenching unit.

5. The system for pyrolysis according to claim 1, wherein each rotary kiln reactor is assigned a quenching unit for condensation and cooling the fission gases and the inner pressure in the rotary kiln reactor and the quenching unit can be regulated by an exhaust fan for suctioning the fission gas products which are not condensed.

6. The system for pyrolysis according to claim 1, characterized by a pyrolysis gas outlet pipe protruding on the discharge side into the reactor drum of the rotary kiln reactor for removing the gaseous fission products from the reaction zone and for passing the fission gases to the quenching unit.

7. The system for pyrolysis according to claim 6, characterized by a circular-shaped cleaning element, provided for cleaning the pyrolysis gas outlet pipe, which encloses the pipe cross-section and which, connected with a gear rack, can be moved forwards and backwards and in the case of which the gear rack is driven by way of a drive gear.

8. The system for pyrolysis according to claim 7, in which the resting position of cleaning element and gear rack is in a pipe piece situated opposite to the pyrolysis gas outlet pipe and this pipe piece is sealed to the environment.

9. The system for pyrolysis according to claim 7 in which the drive energy is transmitted to the gear rack by means of an outlying gear motor with a gas-tight shaft through-passage to the gearwheel.

10. The system for pyrolysis according to claim 1 for the targeted adaptation of the zone-related remain times of the pyrolysis material within the reactor drum, characterized in that the transport spirals have different spacings and pitches, the diameter of the reactor drum is adapted to the individual zones.

11. The system for pyrolysis according to claim 1, wherein between the conveying devices, small lifting blades are arranged at regular intervals for the improved mixing of the fill in the reactor drum.

12. A method for generating pyrolysis solid material from old rubber for the further use as a starting material for the production of recovered carbon black by means of a system according to claim 1, wherein the heating gas generated in the burner unit is mixed with a recirculated heating gas and is supplied by heating gas inlet flaps to the heating jacket space of the rotary kiln reactor, wherein the heat quantity and its distribution is supplied according to requirements to the reactor interiors, in that the heat flow distribution is adjusted by heating gas outlet flaps arranged over the heating jacket spaces and their degree of opening, wherein the heating gases of both rotary kiln reactors leaving the heating jacket spaces are combined in a heating gas recirculation line and are supplied to a heating gas mixing section.

13. The method according to claim 12, wherein surplus heating gas is guided past the rotary kiln reactors by way of a bypass and is supplied to a further thermal use.

14. The method according to claim 12, in which the heating gas generated in the burner unit has a temperature of 850 to 900° C., preferably 870° C.

15. The method according to claim 12, in which the temperature of the heating gas mixture of recirculated heating gas and the heating gas from the burner unit has a temperature of between 580 and 680° C., preferably 650° C.

16. The method according to claim 12, in which the distribution of the heating gas flow in the reactor jacket is adjusted by means of the opening degree of three to five, preferably four heating gas outlet flaps distributed evenly along the axis and arranged at the top.

17. The method according to claim 16, in which the heating gas outlet flaps are adjusted such that a heat distribution in the form of heating gas volume flow results in the proportion of 18% to 22% for the heating zone, 65% to 75% for the reaction zone and 8% to 12% for the degassing zone.

18. The method according to claim 12, in which the inner pressure in the rotary kiln reactor and the quenching unit is between 0.5 and 1.5 mbar above atmospheric pressure.

19. The method according to claim 17 in which, by increasing or reducing a quench cooling capacity and therewith the outlet temperature of the fission gases, the quantity of fission gas which is not condensed is influenced such that requirement fluctuations in the heating capacity of the burner unit are to the main extent compensated, as a result of which the use of primary energy sources such as natural gas or liquid gas can be avoided.

20. The method according to claim 17, in which the two suction fans supply the syngas/pyrolysis gas to a common burner system and realize a supply pressure of 20 to 60 mbar above atmospheric pressure, preferably 40 mbar above atmospheric pressure.
